(19) United States
(12) Patent Application Publication
(10) Pub. No.: US 2013/0135665 A1
(43) Pub. Date: May 30, 2013

(54) PRINTING SYSTEM

(71) Applicants: Frank GRIFFITH, Alabaster, AL (US); Eric Grisham, Maylene, AL (US); Raj Batchu, Pelham, AL (US); Trey Clark, Hartselle, AL (US)

(72) Inventors: Frank GRIFFITH, Alabaster, AL (US); Eric Grisham, Maylene, AL (US); Raj Batchu, Pelham, AL (US); Trey Clark, Hartselle, AL (US)

(21) Appl. No.: 13/432,369

(22) Filed: Mar. 28, 2012

Related U.S. Application Data
(60) Provisional application No. 61/468,300, filed on Mar. 28, 2011.
(60) Provisional application No. 61/472,334, filed on Apr. 6, 2011.

(51) Int. Cl. G06F 3/12

(52) U.S. Cl. CPC G06F 3/1296
USPC 358/1.15

(57) ABSTRACT

A system for providing printing services at an education institution, campus, airport, shopping mall, or similar area through a plurality of separate, stand-alone printing kiosks or similar devices in several locations. The system comprises a software platform in a network or “cloud” environment connecting the printing kiosks in a network. The network can be wired or wireless. The system enables users to print from any location to the network of kiosks. The user uploads the document or file to be printed from his or her computing device, smartphone, or similar device to the printing network or “cloud,” and is given a release code. With the release code, or in an alternative embodiment, with a user name and password, the user can access and print out the document at any particular kiosk throughout the world. Users also may access the printing services directly at the kiosks.

This application claims benefit of and priority to U.S. Provisional Applications Nos. 61/468,300, filed Mar. 28, 2011, and 61/472,334, filed Apr. 6, 2011, and is entitled to that filing date for priority. The specifications, figures and complete disclosures of U.S. Provisional Applications Nos. 61/468,300 and 61/472,334 are incorporated herein by specific reference for all purposes.

### FIELD OF INVENTION

This invention relates to a system, device and related methods for providing printing services. More particularly, this invention relates to a system, device and methods for providing printing services on a campus or similar location.

### BACKGROUND OF THE INVENTION

The use of mobile computing devices such as laptops, tablets, notebooks, and smart phones has greatly expanded in recent years. However, while users can easily and efficiently browse the Internet, communicate with friends, create and manipulate photographs and documents, and engage in a wide variety of creative activities in a great number of locations, their ability to print documents or otherwise create hard copies of their work has not kept up. Users must find printers, which typically are not readily available or accessible. Moreover, due to the cost of printing and printing supplies, there is no incentive for entities to provide printers or access to printers.

### SUMMARY OF THE INVENTION

In various exemplary embodiments, the present system provides printing services at an education institution, campus, airport, shopping mall, or similar area through a plurality of separate, stand-alone printing kiosks or similar devices in several locations. The system comprises a software platform in a network or “cloud” environment connecting the printing kiosks in a network. The network can be wired or wireless.

The system enables users to print from any location to the network of kiosks. The user uploads the document or file to be printed from his or her computing device, smartphone, or similar device to the printing network or “cloud,” and is given a release code. All documents and file types can be handled on a single system or server. With the release code, or in an alternative embodiment, with a user name and password, the user can access and print out the document at any particular kiosk throughout the world. Users also may access the printing services directly at the kiosks, such as by using a USB flash drive or smartphone (e.g., iPhone, Droid, Blackberry) Users pay for printing services via credit card, prepaid card, student identification card, account, online account, or other means for the services.

In one embodiment, the system is a turnkey system with service and support provided by the supplier. The system provider installs the print system, including kiosks, at no charge to the academic institution or site host. In exchange, the system provider may enter into a revenue-sharing agreement with the institution. In one embodiment, the institution and supplier share the revenues generated by the system.

### BRIEF DESCRIPTION OF THE DRAWINGS

FIG. 1 shows a view of a kiosk in accordance with an embodiment of the present invention.

FIG. 2 shows alternative views of a kiosk in accordance with another embodiment of the present invention.

### DETAILED DESCRIPTION OF EXEMPLARY EMBODIMENTS

In various exemplary embodiments, the present system provides printing services at an education institution, campus, airport, shopping mall, or similar area through a plurality of separate, stand-alone printing kiosks 2 or similar devices in several locations. The system comprises a software platform in a network or “cloud” environment connecting the printing kiosks in a network. The network can be wired or wireless, or a combination thereof.

The system enables users to print from any location to the network of kiosks. The user uploads the document or file to be printed from his or her computing device, smartphone, or similar device to the printing network or “cloud,” and is given a release code. All documents and file types can be handled on a single system or server. With the release code, or in an alternative embodiment, with a user name and password, the user can access and print out the document at any particular kiosk throughout the world. Users also may access the printing services directly at the kiosks, such as by using a USB flash drive or smartphone (e.g., iPhone, Droid, Blackberry) Users pay for printing services via credit card, prepaid card, student identification card, account, online account, or other means for the services.

In one embodiment, the system is a turnkey system with service and support provided by the supplier. The system provider installs the print system, including kiosks, at no charge to the academic institution or site host. In exchange, the system provider may enter into a revenue-sharing agreement with the institution. In one embodiment, the institution and supplier share the revenues generated by the system.

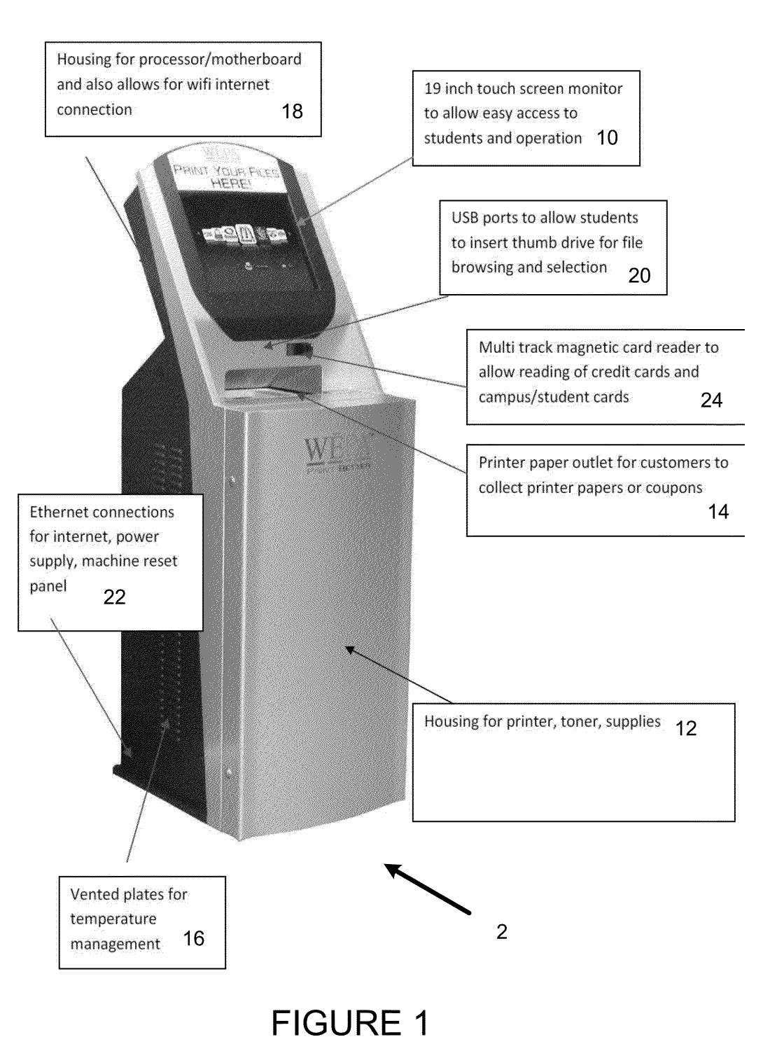

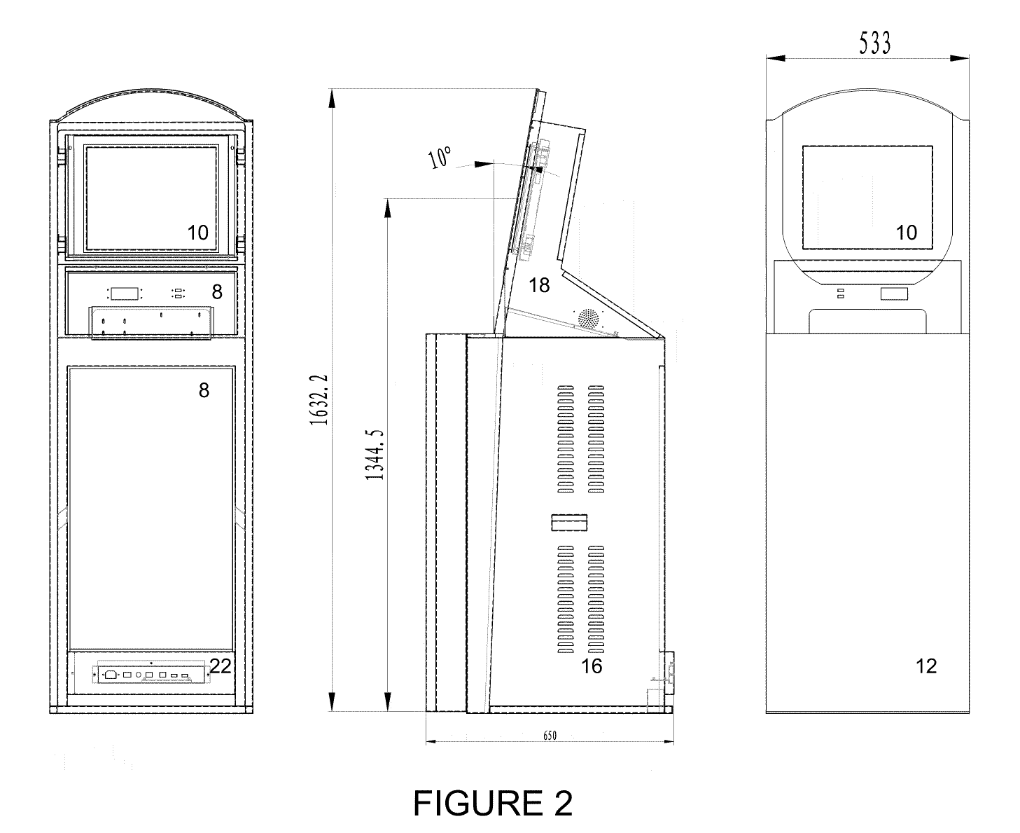

In one particular embodiment, as shown in FIGS. 1 and 2, the system comprises a plurality of kiosks 2. The kiosk is self-contained, and can be chained or securely installed in a particular location as a freestanding or stand-alone unit. In one embodiment, a kiosk can operate on standard 110-volt power (or other electrical power source), and connects to the Internet or local network through a wired, wireless or aircard broadband connection. The kiosk may accept campus cards, credit cards, debit cards, or system print cards for payment. In some embodiments, the kiosk may accept cash or checks.

In the embodiment shown in FIG. 1, each kiosk 2 comprises a user friendly, touch-screen interface 10, with a high-quality, high-definition, color duplex laser printer 8, or the equivalent, contained inside a secure housing 12. The secure housing also may be used for holding paper, ink, toner and other printing supplies. A printer paper outlet 14 allows the user to collect the paper or coupons being printed. One or more sides of the housing have vents 16 to allow the flow of air and reduced temperatures inside the housing. The upper part of the housing 18 securely contains a processor or microprocessor unit, and may incorporate a wireless (wifi) module. One or more external ports 20, including but not limited to a USB, USB2, or similar interface, allows the user to insert a “thumb drive” or USB connector from a tablet or other portable computing device. External connections 22 also may include a power cable outlet or plug, Ethernet or wired Internet connection or port, and a machine reset panel. A magnetic card reader 24 also is provided to allow the reading of campus cards, students cards, credit cards, or similar cards. Kiosks may be configured identically, and use high quality paper to ensure smooth operation.

In another embodiment, a print kiosk also may be used as a campus utility or information station. A school or institution can push RSS feeds or other forms of information to the kiosk for display and communication to students through the display interface 10. Examples of such notices include game day parking announcements, academic calendars, holiday announcements, road closures, construction, departmental announcements, emergencies, lockdown notifications, health notifications, bad weather alerts, class registration reminders and deadlines, campus store hours and information, cafeteria hours and information, student recreation hours and information, seminars, videos, flash movies, and sporting events. In one embodiment, an integrated mapping system allows students or users to see a map of all kiosks located on the campus or in the facility at the touch of a button. The kiosk exterior can be customized with school colors or logos, or may be marked with other logos, images, and the like.

In yet another embodiment, the system comprises a coupon delivery service, where users can obtain coupons printed at a kiosk. The coupons may be funded or supplied or sponsored by national or local vendors. Similarly, the kiosk may present paid and unpaid advertising.

In a further embodiment, the system is a turnkey operation installed at a school or similar institution at no cost to the school or institution or host. It significantly upgrades the school's student printing function, and potentially creates new revenue streams for the school or institution or host (e.g., through sharing of revenue from the printer kiosk operation).

In yet another embodiment, the system can provide for both partial and complete printing by students and others of textbooks, student workbooks, and many other types of printed materials, including, but not limited to, reference materials. The system also may provide for uploading of student assignments by teachers, and printing of those assignments by students. Printing may be done at any system kiosk, whether schoolwide or worldwide. Printing also may incorporate release codes and magnetic reading of student cards or other forms of identification to aid in student authentication and authorized printing.

Similarly, the system may be used to sell and print a variety of books, magazines, and other printed materials. Reading material of all varieties may be converted from digital form to printed form. Kiosks may be located in bookstores, newsstands, or similar locations.

In these embodiments, the revenue sharing component thus may allow revenue sharing by the service provider with the publisher along with the school, institution, or host. The business model, for example, may include a rebate to the school, institution or host, a fee to the publisher or intellectual property rights holder, and a commission to the service provider.

Accordingly, the system can be used in a wide variety of commercial applications where organizations want to closely track and, in some cases, charge for printing of documents and flyers. The system may thus be used to vend printed files uploaded from computers, smart phones, or other similar devices. The vending and printing may take place at any print kiosk worldwide. Examples of such commercial applications include, but are not limited to, airports, hotels, bookstores, and real estate offices.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for providing printing services, comprising:
a plurality of kiosks connected to a network, each kiosk comprising a housing containing a printer, a processor or microprocessor unit, and a touch-screen monitor;
wherein the system provides a release code to a user when the user submits a document to be printed to the system, and the system prints a document at a particular kiosk in response to the user providing a release code at that kiosk.

2. The system of claim 1, wherein one or more of the kiosks are wirelessly connected to the network.

3. The system of claim 1, wherein one or more of the kiosks are freestanding kiosks.

4. The system of claim 1, wherein one or more of the kiosks further comprise a USB interface port.

5. The system of claim 1, wherein one or more of the kiosks further comprise an Ethernet or wired Internet connection.

6. The system of claim 1, wherein one or more of the kiosks further comprise a magnetic card reader.

7. The system of claim 6, wherein the magnetic card reader is used to accept payment from the user.

8. The system of claim 7, wherein two or more kiosks are located at an educational institution.

9. The system of claim 8, wherein the magnetic card reader is adapted to read a student identification or campus card.

10. The system of claim 8, wherein kiosks also provide information or announcements to students through the display.

11. The system of claim 8, wherein kiosks also provide printed copies, in whole or in part, of textbooks, workbooks and other educational materials.

12. The system of claim 8, wherein kiosks also provide copies of student or class assignments.

13. The system of claim 8, where the educational institution receives a share of the revenue generated by kiosks at the educational institution.

14. The system of claim 1, wherein a kiosk also prints coupons selected by a user interacting with the kiosk.
